(19) United States
(12) Patent Application Publication
(10) Pub. No.: US 2026/0286776 A1
(43) Pub. Date: Sep. 24, 2026

(54) TRUSS FRAME COUPLING ASSEMBLY FOR JOINING FIRST AND SECOND PLANAR FRAMES OF A CUBOID GATE FRAME

(71) Applicant: Secure Orbit Inc., Thunder Bay (CA)

(72) Inventor: Tyler Bragnalo, Thunder Bay (CA)

(21) Appl. No.: 19/082,946

(22) Filed: Mar. 18, 2025

(51) Int. Cl. E06B 11/02; E06B 11/04; F16B 2/06

(52) U.S. Cl. CPC E06B 11/026; E06B 11/045; F16B 2/06; E05Y 2900/40

(57) ABSTRACT

A gate assembly for a gate opening in a perimeter fence or wall includes a stationary frame supported on ground adjacent to the gate opening and a cuboid gate frame for translating movement relative to the gate opening between open and closed positions. The cuboid gate includes first and second planar frames and a coupling assembly coupling the first planar frame and the second planar frame to span a length of the cuboid gate frame at laterally opposing sides of the cuboid gate frame. The coupling assembly uses mounting brackets mechanically clamped with threaded fasteners onto respective ones of the first and second planar frames so that a plurality of truss frame assemblies can be connected between the mounting brackets to span a width of the cuboid gate frame between the first and second planar frames such that the truss frame assemblies stiffen the planar frames against lateral bending.

### FIELD OF THE INVENTION

The present invention relates to a cuboid frame of a gate for translating movement relative to a gate opening, and more particularly the present invention relates to a coupling assembly including at least one truss frame for coupling between two planar gate frames to collectively define the cuboid frame while stiffening each of the first planar frame and the second planar frame against bending in a transverse lateral direction.

### BACKGROUND

In a gate structure for large gate openings in a perimeter wall or perimeter fence structure, for example gate openings of the type arranged to receive vehicles and the like passing therethrough, it is common to provide an elongated gate frame supported for translating movement on a stationary frame adjacent to the gate opening such that the gate frame can be displaced between a closed position spanning the gate opening and an open position in which the gate opening is substantially unobstructed by the gate frame. A typical gate frame comprises a top rail and a bottom rail joined by longitudinally spaced vertical posts connected between the rails so that the posts and the rails lie within a generally common plane. While a gate frame of this configuration has suitable strength to resist bending within a vertical plane so as to be suitable for supporting the gate frame in a cantilevered manner, the planar arrangement of the gate frame is not suited for applications where the gate frame may be subjected to high lateral loads from wind or attempts to overcome the gate with lateral impacts.

### SUMMARY OF THE INVENTION

According to one aspect of the invention there is provided a coupling assembly arranged for assembling a first planar frame and a second planar frame to collectively define a cuboid gate frame which is elongated in a longitudinal direction and which is arranged to be operatively supported for translating movement in the longitudinal direction relative to a gate opening, the coupling assembly comprising:

a plurality of mounting brackets arranged to be mechanically coupled onto respective ones of the first planar frame and the second planar frame; and

at least one truss frame assembly arranged to be connected between the mounting brackets of said plurality of mounting brackets such that the first planar frame and a second planar frame are parallel and spaced apart from one another in a lateral direction to extend in the longitudinal direction along a length of the cuboid frame at laterally opposing sides of the cuboid frame;

whereby said at least one truss frame assembly stiffens each of the first planar frame and the second planar frame against bending in said lateral direction.

The arrangement of mounting brackets which can be mechanically coupled onto existing first and second planar gate frames and truss frames which can be mounted between mounting brackets on the first and second planar date frames allows the planar frames be effectively assembled using on-site tools into a three-dimensional cuboid gate frame which has much greater strength to resist lateral loads from wind or impacts to improve the operation and security of the resulting gate structure.

Preferably each mounting bracket is mechanically coupled to the respective one of the first and second planar frames using threaded fasteners.

Preferably each mounting bracket is arranged to be clamped onto the respective one of the first and second planar frames.

Preferably each of the first and second planar frames includes a top rail, a bottom rail and a plurality of frame posts extending in fixed relation between the top rail and the bottom rail at longitudinally spaced positions, in which each mounting bracket is arranged to be mounted onto the respective one of the first and second planar frames adjacent a junction of one of the posts with one of the top rail and the bottom rail.

When each frame post of each of the first and second planar frames is secured to each of the top rail and the bottom rail of that planar frame by a respective gusset member of that planar frame, each mounting bracket may further include a locating member arranged to be received in a gusset opening between the post and the respective gusset member of the planar frame so as to be arranged to locate the mounting bracket relative to the respective planar frame.

When each mounting bracket is clamped onto the planar frame using threaded fasteners extending through fastener openings in the mounting bracket, the fastener openings are preferably elongated in said longitudinal direction of the gate frame.

Each truss frame assembly preferably includes a top subassembly adjacent a top of the cuboid gate frame and a bottom subassembly adjacent a bottom of the cuboid gate frame, in which each of the top subassembly and the bottom subassembly includes two crossbars arranged to extend perpendicularly between the first planar frame and the second planar frame and a plurality of struts connected between the two crossbars. The plurality of struts of each of the top subassembly and the bottom subassembly of said at least one truss frame assembly may be pivotally attached to the crossbars such that each of the top subassembly and the bottom subassembly are pivotal between (i) a working position arranged to span a width between the first planar frame and the second planar frame and (ii) a collapsed position in which the struts lie parallel and alongside the crossbars.

Each of the crossbars may comprise a channel member having a C-shaped profile arranged to receive at least one of the struts nested therein in the collapsed position.

Each truss frame assembly preferably further comprises at least one vertical frame comprising a plurality of struts coupled between the top subassembly and the bottom subassembly. The struts of said at least one vertical frame may be foldable from (i) a working position arranged to span a width between the first planar frame and the second planar frame and (ii) a collapsed position in which the struts lie parallel and alongside one another.

Preferably a plurality of the truss frame assemblies are arranged to be mounted longitudinally end to end with one another such that the truss frame assemblies collectively occupy the length of the cuboid frame.

At least one of the mounting brackets may comprise a common mounting bracket receiving two adjacent ones of the truss frame assemblies partially mounted thereon.

The coupling assembly may further include a wheel assembly arranged to be mounted onto the first planar frame and the second planar frame, in which the wheel assembly has a pair of laterally opposing mounting flanges arranged to be mounted onto the first planar frame and the second planar frame respectively while the wheel assembly spans a width of the cuboid frame in the lateral direction. When the first planar frame and the second planar frame each comprise a modular frame formed of modular sections joined longitudinally end to end with one another, the mounting flanges of the wheel assembly may be each arranged to span a junction between an adjacent pair of the modular sections of the such that the mounting flange forms a bridge connected to each modular sections of the adjacent pair.

According to a second aspect of the present invention there is provided a gate assembly comprising:

a stationary frame arranged to be supported on ground adjacent to a gate opening; and

a cuboid gate frame which is elongated in a longitudinal direction and which is supported on the stationary frame for translating movement in the longitudinal direction relative to a gate opening between a closed position spanning the gate opening and an open position in which the gate opening is substantially unobstructed by the cuboid gate frame;

the cuboid gate frame comprising:

a first planar frame and a second planar frame extending in the longitudinal direction along a length of the cuboid frame at laterally opposing sides of the cuboid frame such that the first planar frame and the second planar frame are parallel and spaced apart from one another in a lateral direction; and

a coupling assembly coupling the first planar frame and the second planar frame, the coupling assembly comprising (i) a plurality of mounting brackets mechanically coupled onto respective ones of the first planar frame and the second planar frame, and (ii) a plurality of truss frame assemblies arranged to be connected between the mounting brackets of said plurality of mounting brackets to span a width of the cuboid gate frame between the first planar frame and the second planar frame in the lateral direction whereby the truss frame assemblies stiffen each of the first planar frame and the second planar frame against bending in the lateral direction.

The truss frame assemblies may be arranged to be mounted longitudinally end to end with one another such that the truss frame assemblies collectively occupy the length of the cuboid frame.

Preferably each truss frame assembly among the plurality of truss frame assemblies comprises (a) longitudinally opposed first and second crossbars extending perpendicularly between the first planar frame and the second planar frame and (b) a plurality of struts pivotally connected between the first and second crossbars such that the truss frame assembly is pivotal between (i) a working position arranged to span a width between the first planar frame and the second planar frame and (ii) a collapsed position in which the struts lie parallel and alongside the first and second crossbars.

The gate assembly may further include a wheel assembly arranged to be mounted onto the first planar frame and the second planar frame, in which the wheel assembly has a pair of laterally opposing mounting flanges arranged to be mounted onto the first planar frame and the second planar frame respectively while the wheel assembly spans a width of the cuboid frame in the lateral direction.

When the wheel assembly includes two wheels supported adjacent to the first and second planar frames respectively and the stationary frame comprises a bottom roller guide mounted thereon at each of the laterally opposing sides of the cuboid frame adjacent to a bottom of the cuboid gate frame, preferably each roller guide comprising a support flange supporting an exterior guide wheel thereon for rolling engagement with an exterior side surface of the cuboid gate frame such that the support flange is mounted in a non-interfering relationship with the wheels of the wheel assembly as the cuboid gate frame is displaced between the open position and the closed position thereof.

### BRIEF DESCRIPTION OF THE DRAWINGS

One embodiment of the invention will now be described in conjunction with the accompanying drawings in which:

FIG. 1 is a perspective view of a gate assembly formed of first and second planar frames connected by a coupling assembly according to the present invention so as to define a cuboid gate frame suited for operation between open and closed positions relative to a stationary frame upon which the cuboid gate frame is supported;

FIG. 2 is a perspective view of one of the truss frame assemblies according to the coupling assembly of FIG. 1, shown in the working position;

FIG. 3 is a perspective view of one half of a truss frame assembly according to the coupling assembly of FIG. 1, shown in the collapsed position;

FIG. 4 is an enlarged perspective view of an upper portion of one of the truss frame assemblies coupled between the first and second planar frames according to the coupling assembly of FIG. 1;

FIGS. 5 and 6 are different perspective views of one of the crossbars of upper portion of the truss frame assembly according to the coupling assembly of FIG. 1;

FIG. 7 is an enlarged perspective view of a lower portion of one of the truss frame assemblies coupled between the first and second planar frames according to the coupling assembly of FIG. 1;

FIGS. 8 and 9 are different perspective views of the mounting location of one of the crossbars of the lower portion of the truss frame assembly according to the coupling assembly of FIG. 1;

FIG. 10 is a perspective view of a wheel assembly according to the coupling assembly of FIG. 1;

FIG. 11 is a perspective view of a bottom of the cuboid gate frame illustrating a junction between adjacent modular sections of the planar frames which represents an alternate mounting location of the wheel assembly; and

FIG. 12 is a sectional view along the line 12-12 in FIG. 1.

In the drawings like characters of reference indicate corresponding parts in the different figures.

### DETAILED DESCRIPTION

Referring to the accompanying figures there is illustrated a cuboid gate frame coupling assembly generally indicated by reference numeral 10. More particularly, the present invention relates to a coupling assembly 10 which is suited for assembling a cuboid gate frame 12 by coupling (i) a first planar frame 14 occupying a first plane and (ii) a second planar frame 16 occupying a second plane such that the first and second planar frames are parallel and spaced apart from one another to span in a longitudinal direction along a length of the elongated cuboid gate frame at laterally opposing sides of the cuboid gate frame.

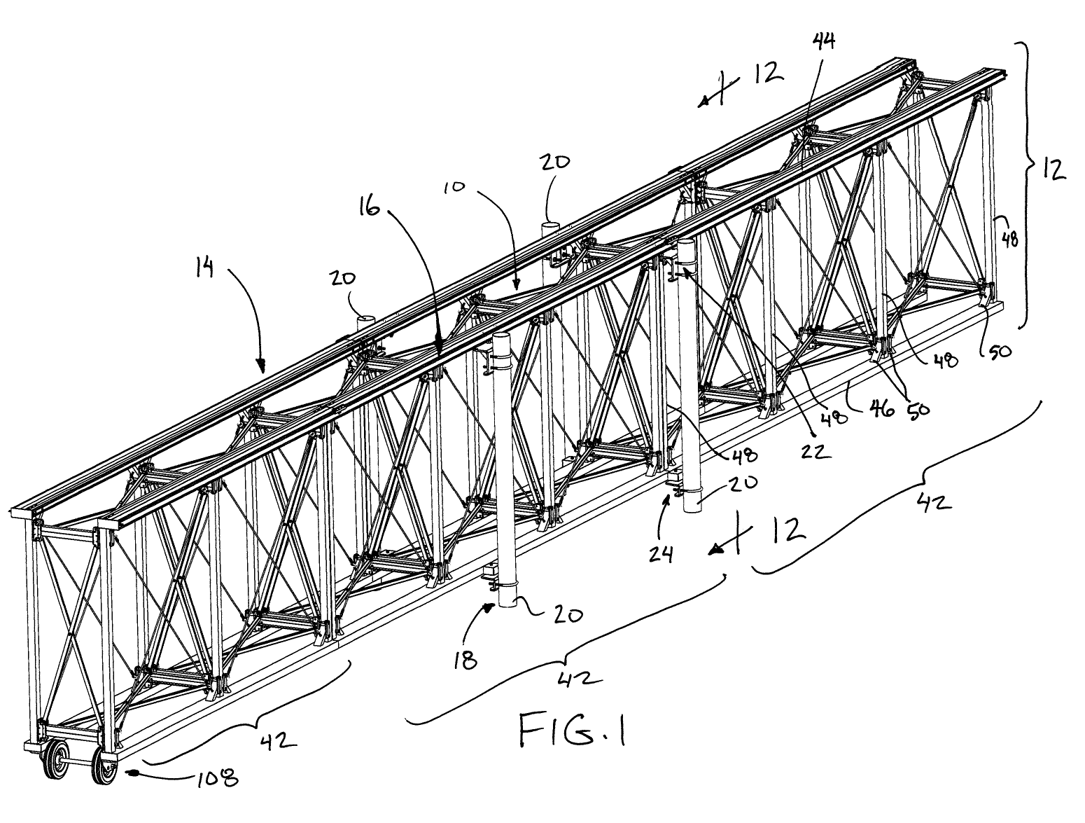

The cuboid gate frame 12 forms part of an overall gate assembly shown in FIG. 1 in which the gate assembly generally includes (i) a stationary frame 18 arranged to be fixed relative to the ground adjacent a gate opening of a perimeter wall or fence structure (not shown), and (ii) the cuboid gate frame 12 which is supported on the stationary frame 18 so as to be movable for translating movement in the longitudinal direction of the cuboid gate frame between a closed position spanning across the gate opening, and an open position in which the gate opening is substantially unobstructed by the cuboid gate frame.

The stationary frame 18 includes a pair of stationary posts 20 supported at longitudinally spaced apart positions at each of the laterally opposing sides of the cuboid gate frame 12. Each of the stationary posts includes a top roller guide 22 adjacent a top of the cuboid gate frame and a bottom roller guide 24 supported adjacent a bottom of the cuboid gate frame. Each top roller guide includes top rollers 26 for engaging a top rail 28 of the respective planar gate frame at the same side of the cuboid gate frame. The top roller guide further includes an angle bracket including a bolt flange 30 arranged to be fastened in a vertical orientation against the respective stationary post 20 and a support flange 32 protruding horizontally from the top of the bolt flange inwardly towards the gate frame for supporting the top rollers 26 rotatably thereon. The top rollers include rollers that rotate about both vertical and horizontal axes for providing both vertical and lateral support to the cuboid gate frame as the cuboid gate frame is displaced longitudinally between the open and closed positions thereof. The configuration of the top rail and the relation to the top rollers is described in further detail below.

Each bottom roller guide 24 includes a bottom roller 34 for engaging a bottom rail 36 of the adjacent planar frame 14 or 16 of the cuboid gate frame. The bottom roller guides 24 each further include an angle bracket having a bolt flange 38 arranged to be fastened vertically against the respective stationary post 20 and a support flange 40 extending horizontally inward from a top of the bolt flange towards the cuboid gate frame for supporting the bottom roller 34 rotatably thereon for rotation about a vertical axis for engaging an exterior side surface of the bottom rail 36 which is described in further detail below.

The first planar frame 14 and the second planar frame 16 are substantially identical to one another. Each planar frame comprises rigid frame members which are coupled together so that the frame primarily lies in a common plane that is vertically oriented at one side of the cuboid gate frame. Each planar frame is formed in modular sections 42 which are mounted end to end with one another in the longitudinal direction of the gate frame. The modular sections may be different in length. In the illustrated embodiment each planar frame comprises a single 10-foot long modular section and two longer 15-foot long modular sections coupled end to end with one another. The seams between adjacent modular sections within each planar frame are staggered relative to the seams of the other planar frame by changing the order of the modular sections. For example, in the illustrated embodiment, one of the planar frames includes a 10-foot section followed by two 15-foot sections, while the other planar frame uses two 15-foot sections followed by a 10-foot section along the length of the gate frame in the same direction from a first end to a second end of the gate frame so that all of the seams between modular sections of one frame are offset longitudinally from the seams of the other frame.

Each modular section 42 is similarly constructed so as to comprise a top rail section 44 spanning the top of the modular section, a bottom rail section 46 spanning a bottom of the modular section, and a plurality of frame posts 48 extending vertically between the top rail section and the bottom rail section at evenly spaced positions in the longitudinal direction. The frame posts are fixed to the top rail and the bottom rail, for example by welding to produce a rigid frame. Typically, a frame post 48 is provided at each of the opposing ends of the modular section and at one or more intermediate locations at a prescribed longitudinal distance from adjacent posts. The longitudinal distance between posts is the same regardless of the length of each modular section by arranging each modular section to have a total length that is a multiple of the prescribed longitudinal distance between adjacent posts.

The frame posts 48 are further supported relative to the top and bottom rails using additional gusset members 50. At each end post, one gusset member 50 is joined between the post and the top rail and another gusset member 50 is joined between the post and the bottom rail so that both ends of the gusset member are spaced from the intersection of the post with the rail to produce a triangular-shaped gusset opening 52 between the gusset member, the post and the rail at each gusset member mounting location. At both top and bottom ends of each intermediate post, a pair of the gusset members 50 are coupled at longitudinally opposed sides of the post to be joined to a respective one of the top or bottom rails at longitudinally spaced locations. Each gusset member 50 is similarly mounted to produce a triangular-shaped gusset opening 52 between the post, the rail, and the gusset member.

The modular sections 42 of the planar frames are mounted end to end such that the top rail sections 44 of adjacent modular sections are aligned with one another and are coupled to form the top rail 28 of the planar frame that spans continuously along the full length of the assembled planar frame. Likewise, the bottom rail sections 46 of the modular sections are aligned with one another and are coupled to form the bottom rail 36 of the planar frame that spans continuously along the full length of the assembled planar frame.

The bottom rail sections 46 each comprise a hollow tubular member having an open end where the modular section is joined to an adjacent modular section. Each bottom rail section 46 is joined to an adjacent bottom rail section 46 using an internal coupling member (not shown) which bridges the junction between the two bottom rail sections by being partly received along a length of each of the bottom rail sections through the open end of the bottom rail sections. The internal coupling member is rigidly fastened to each of the bottom rail sections to couple the rail sections end to end with one another to collectively form the continuous bottom rail 36 of the planar frame.

Each top rail section 44 is an extruded member having a continuous profile that includes a closed cell portion 54 and an adjacent C-shaped channel 56 that is mounted to the exterior side of the closed cell portion 54 while being open at the bottom side. The closed cell portion 54 is aligned with the frame posts 48 and the bottom rail section 46 to define the common plane of the planar frame. The C-shaped channel portion 56 protrudes slightly to the exterior side of the planar frame for receiving the top rollers 26 of the top roller guides 22 therein. The top rollers 22 include horizontal axis rollers supporting the vertical load of the planar frame suspended thereon in addition to vertical axis rollers that engage the interior sidewalls of the C-shaped channel 56 to locate the planar frame laterally relative to the stationary frame. The bottom rail 36 is only engaged at the exterior side surface by the vertical axis bottom rollers 34 to provide support in the lateral direction.

The coupling assembly 10 according to the present invention generally comprises (i) a plurality of mounting brackets 60 arranged for clamping onto the first and second planar frames 14 and 16 using threaded fasteners, and (ii) a plurality of truss assemblies 62 fastened between mounting brackets 60 on the planar frames such that the truss assemblies span a width of the cuboid gate frame between the first planar frame and the second planar frame while each occupying a portion of the length of the cuboid frame in the longitudinal direction. More particularly, a plurality of the truss assemblies 62 are mounted end to end with one another in the longitudinal direction along the length of each modular section such that a group of the truss assemblies collectively span the length of each modular section while the overall arrangement of truss assemblies are coupled end to end with one another to span the full length of the cuboid gate frame.

Each mounting bracket 60 is mounted onto a respective one of the first or second planar frames at the location of one of the gusset members 50 so as to be situated adjacent a junction of a respective one of the frame posts 48 with the top rail at the top of the cuboid frame or with the bottom rail section at the bottom of the cuboid gate frame. More particularly, each mounting bracket includes a first clamping member 64 at the exterior side of the respective planar frame and a second clamping member 66 at the interior side of the respective planar frame. Each pairing of a first clamping member and a second clamping member receives a respective portion of the respective planar frame clamped therebetween using threaded fasteners operatively connected between the first clamping member and the second clamping member.

Each first clamping member 64 is a plate body which is generally elongated in a vertical direction and which includes an inside face for abutment against an exterior side surface of the respective gusset member 50. A pair of locating members 70 are formed on the plate body to protrude inwardly relative to the inside face of the clamping member. The two locating members are located at vertically spaced positions adjacent opposing top and bottom ends of the first clamping member so as to be sufficiently spaced apart to receive the respective gusset member 50 therebetween in the vertical direction. The locating members are symmetrical with one another about a horizontal axis. Each locating member includes a vertical alignment face 72 arrange for abutment against a vertical side surface of the respective frame posts 48 and a sloped face 74 at the opposing side of the locating member in the longitudinal direction of the gate frame which is sloped to match the sloped orientation of the respective gusset member. Each of the locating members 70 is shaped to be tapered in width towards the opposing locating member. In this manner, the first clamping member can be accurately located relative to the planar frame by abutting both vertical faces 72 of the two locating members against the vertical side surface of the frame post while further abutting the sloped face 74 with a corresponding surface of the gusset member at an interior angle between the gusset member and the frame post to locate the first clamping member vertically relative to the planar frame.

A pair of fastener apertures 76 communicate through the first clamping member in the lateral direction of the cuboid frame to receive the clamping fasteners 68 of the mounting brackets extending therethrough. The fastener openings are elongated in the longitudinal direction of the cuboid gate frame to allow some relative adjustment of the fasteners 68 relative to the first clamping member 64. Fastener openings 76 extend through the first clamping member in alignment with each of the locating members 70 respectively.

The second clamp member 66 varies in configuration depending upon the mounting location within each planar frame. At the location of an intermediate frame post 48 at an intermediate location along one of the modular sections of the planar frame, a dual second clamping member 66A is sized to overlap both first clamping members clamped against both gusset members 50 of the post in the longitudinal direction. The dual second clamping member 66A thus aligns with the clamping fasteners 68 of both first clamping members 64 associated with that post so that the dual second clamping member 66A is clamped against the inner side surface of the post by two vertically spaced clamping fasteners 68 at each of the longitudinally opposed sides of the frame post. The clamping fasteners 68 are received within corresponding fastener apertures in the body of the second clamping member in alignment with each of the fasteners.

Alternatively, at the location of an end frame post 48 at the end of one of the modular sections of the planar frame, an individual second clamping member 66B is provided having a width in the longitudinal direction of the planar frame that is only slightly greater than the width of the corresponding end post. In this manner, the second clamping member protrudes only to the side of the post locating the gusset member 50 coupled thereto. The individual second clamping member 66B thus only has two fastener apertures therein for alignment with the two clamping fasteners 68 of the respective first clamping member 64 on the opposing exterior side of the planar frame.

Despite two configurations of the second clamping member 66A or 66B, the common features will now be described. In each instance the second clamping member comprises a flat plate body having an exterior side surface clamped against the interior side surface of the planar frame and a mounting face 78 at the interior side of the planar frame which is parallel to the planar frame so as to be vertically oriented and parallel to the longitudinal direction of the cuboid frame for mounting a respective portion of one of the truss assemblies 62 abutted thereon. Each plate forming the body of the second clamp member further includes a plurality of exterior sockets 80 aligned with respective ones of the clamping fasteners 68 to receive a respective clamping fastener threaded therein and a plurality of interior threaded sockets 82 open to the interior of the cuboid frame for receiving corresponding fasteners of the truss assemblies threaded therein for in turn fastening the truss assemblies to the mounting brackets.

As described above, each planar frame 14 or 16 is further divided into a plurality of subsections having a prescribed length in the longitudinal direction corresponding to the longitudinal distance between two posts of the frame. The subsections among all of the modular sections are equal in length while some modular sections are longer than others by having a different number of frame posts 48, and thus a different number of subsections. Each truss assembly 62 spans a length in the longitudinal direction corresponding to the length of one subsection of the corresponding modular frames between which the truss assembly is connected.

The mounting brackets 60 are located at the junction of each frame post 48 with each of the top rail and the bottom rail of the respective planar frames. When each truss assembly spans the length of one subsection of each of the planar frames, this results in a first clamping member 64 being situated at each of the eight corners of the cubic shape of the truss assembly. As described above, some of the first clamping members 64 are associated with their own respective individual second clamping member 66B, whereas some of the first clamping members 64 at the location of intermediate frame posts are joined to a common dual second clamping member 66A.

In each instance, the four bottom corners of the cubic truss assembly are aligned with and fastened to a respective set of four second clamping members corresponding to two second clamping members longitudinally spaced along the bottom rails of the first and second planar frames respectively. Likewise, the four top corners of the cubic truss assembly are aligned with and fastened to a respective set of four second clamping members corresponding to two second clamping members longitudinally spaced along the top rails of the first and second planar frames respectively.

Each truss assembly generally includes a top subassembly 84 extending horizontally at the top of the truss assembly adjacent to the top rails of the first and second planar frames, and a bottom subassembly 86 extending horizontally at the bottom of the truss assembly adjacent to the bottom rails of the first and second planar frames. Each truss assembly further includes two vertical frames 88 oriented perpendicularly to the longitudinal direction of the cuboid gate frame so as to be situated at longitudinally opposed ends of the truss assembly, each connected between a respective end of the top subassembly 84 and a respective end of the bottom subassembly 86.

Each of the top and bottom subassemblies includes first and second crossbars 90 oriented parallel to one another at opposing ends of the truss assembly to extend perpendicularly to the planar frames 14 and 16 between which the crossbars are mounted. Each crossbar 90 has a channel portion 92 having a C-shaped profile extending along a majority of the length of the crossbar so as to have an open side facing to the interior towards the other crossbar in a working position mounted between the planar frames. A pair of mounting blocks 94 are fixed at opposing ends of the channel 92 in which each mounting block includes an outer end face that is flat and perpendicular to a longitudinal direction of the channel for abutment flat against a corresponding mounting face 78 of the respective second clamp member onto which the crossbar is fastened.

Each of the top subassembly and the bottom subassembly further includes a pair of struts 96 pivotally mounted onto respective top and bottom flanges of the C-shaped profile of the channel 92 such that in a working position of the truss assembly mounted between the first and second planar frames, the struts extend in an X-shaped pattern between the crossbars 90. Each strut is thus mounted onto one of the crossbars 90 at an end of the crossbar adjacent to the first planar frame 14 while being mounted on the other crossbar at an opposing end of the crossbar adjacent to the second planar frame 16. At each crossbar, the two struts of the respective subassembly are mounted at opposing ends of the crossbar so that the struts intersect one another at a central location along each strut in the working position of the subassembly mounted between the first and second planar frames.

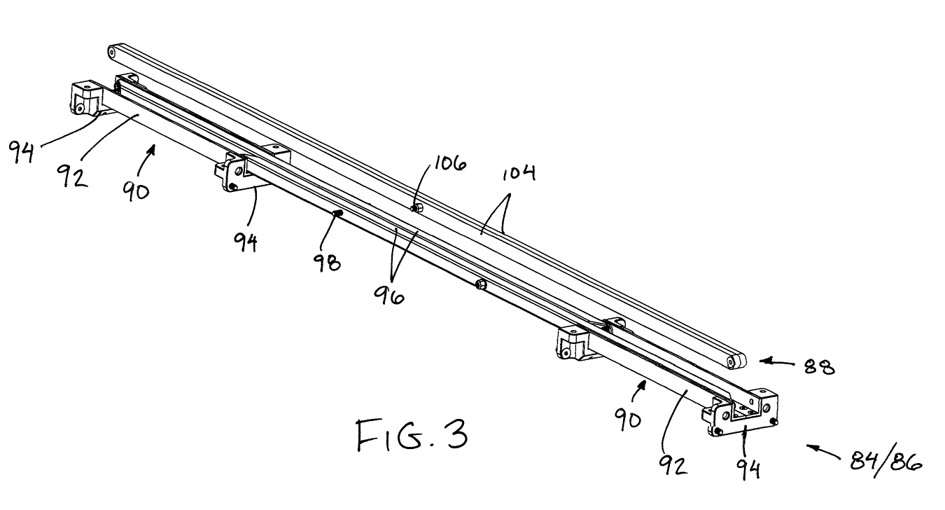

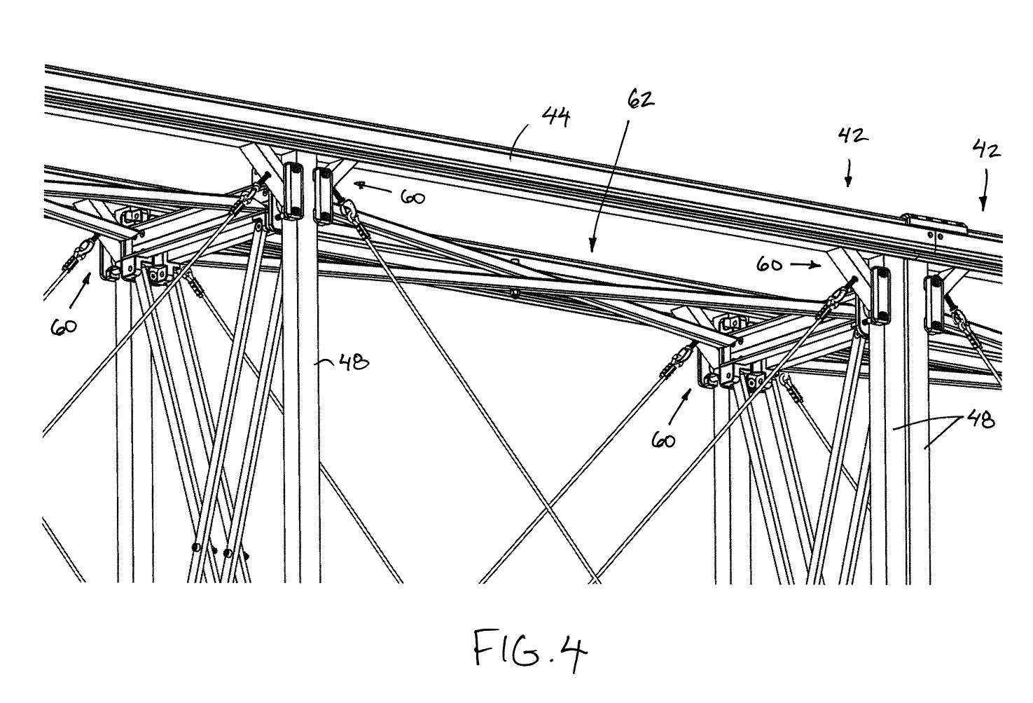

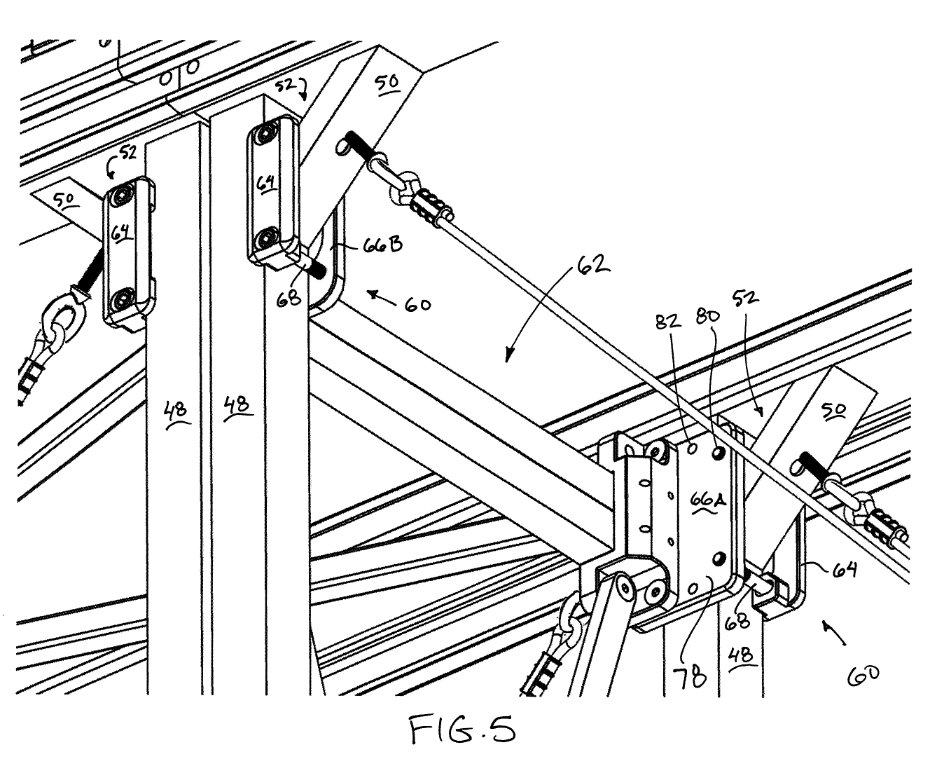

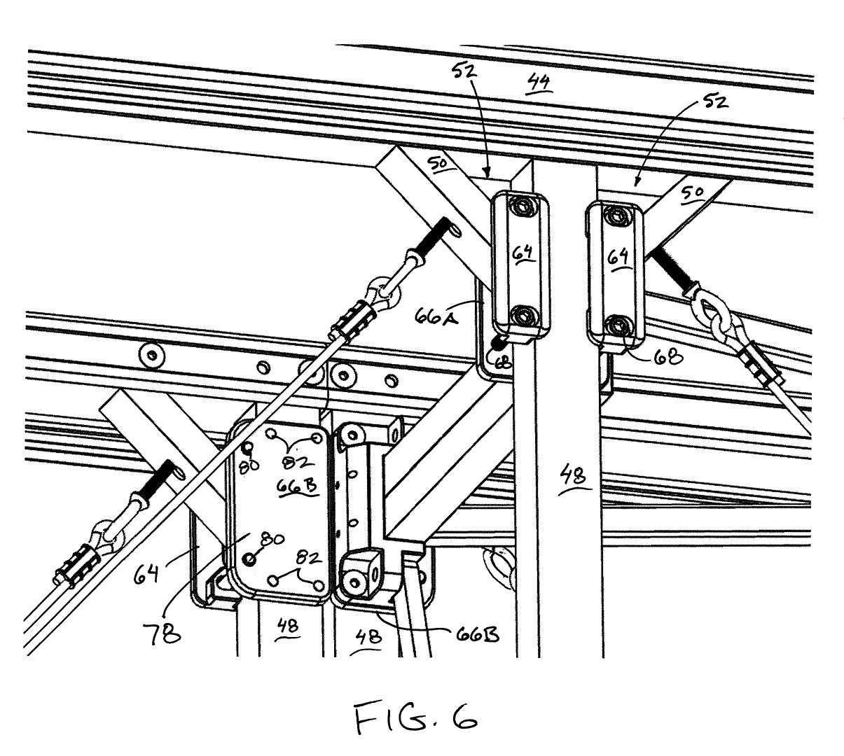

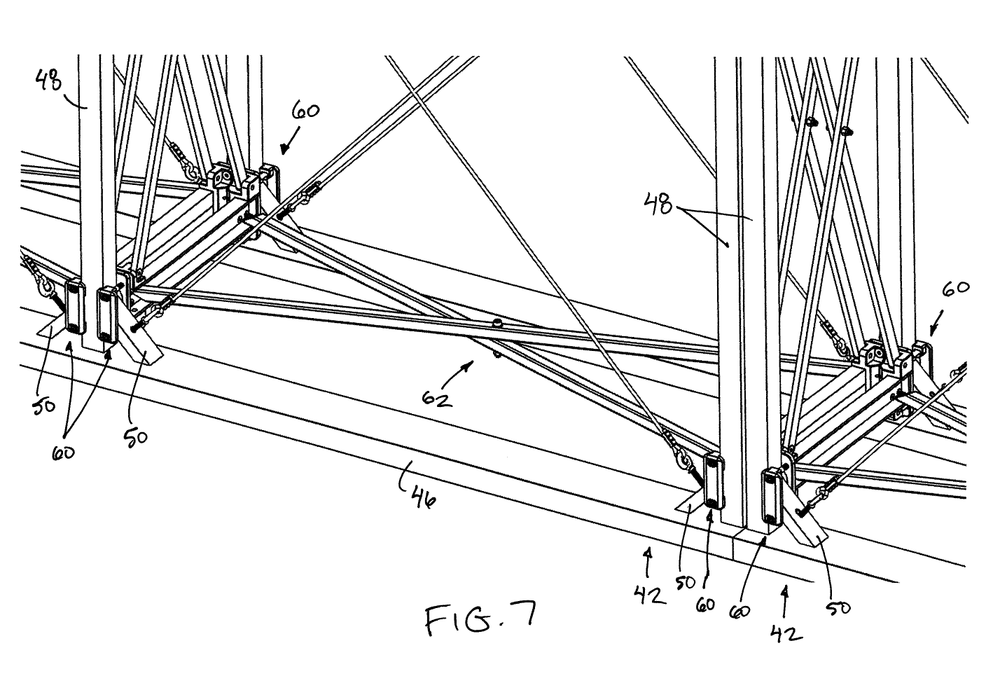

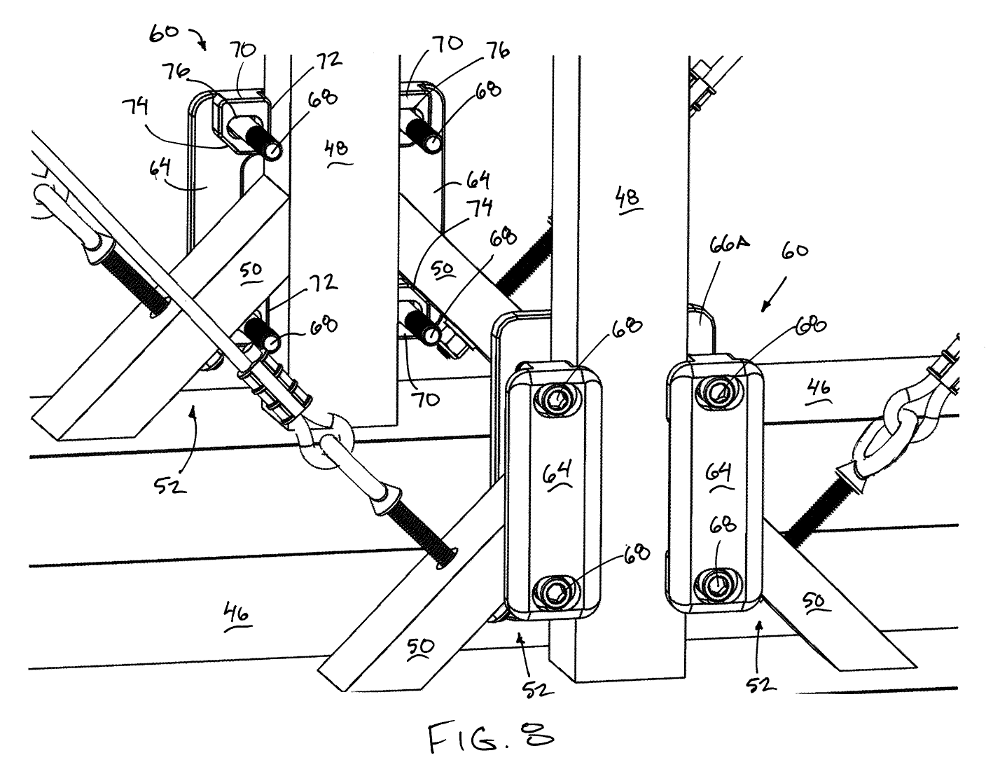

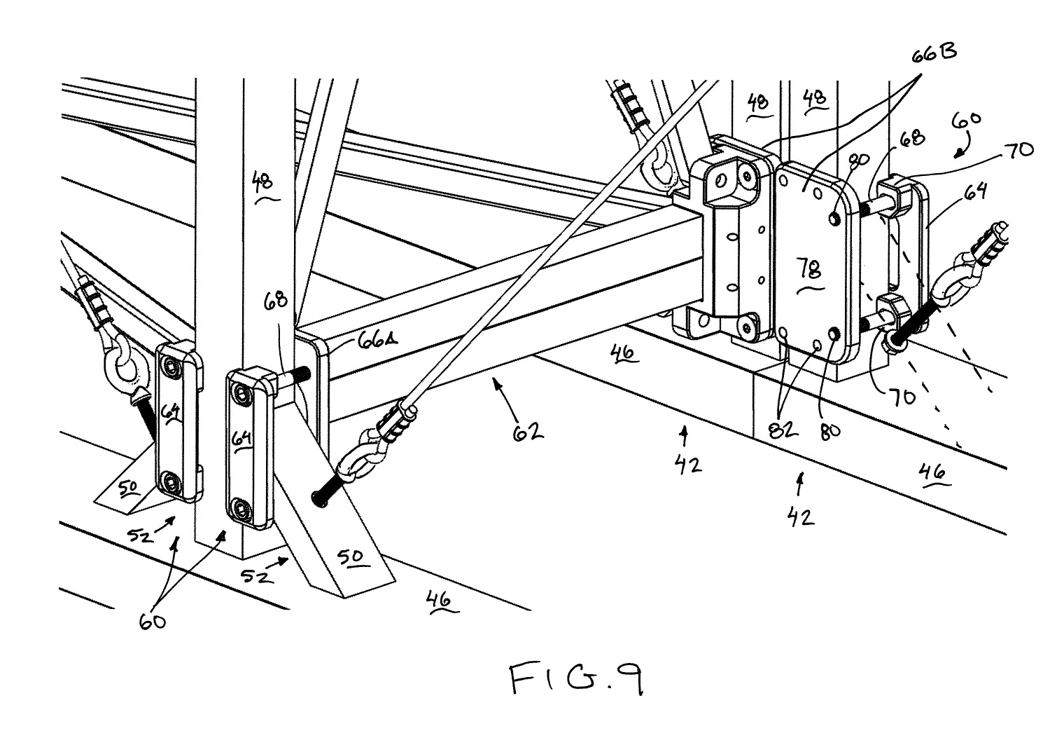

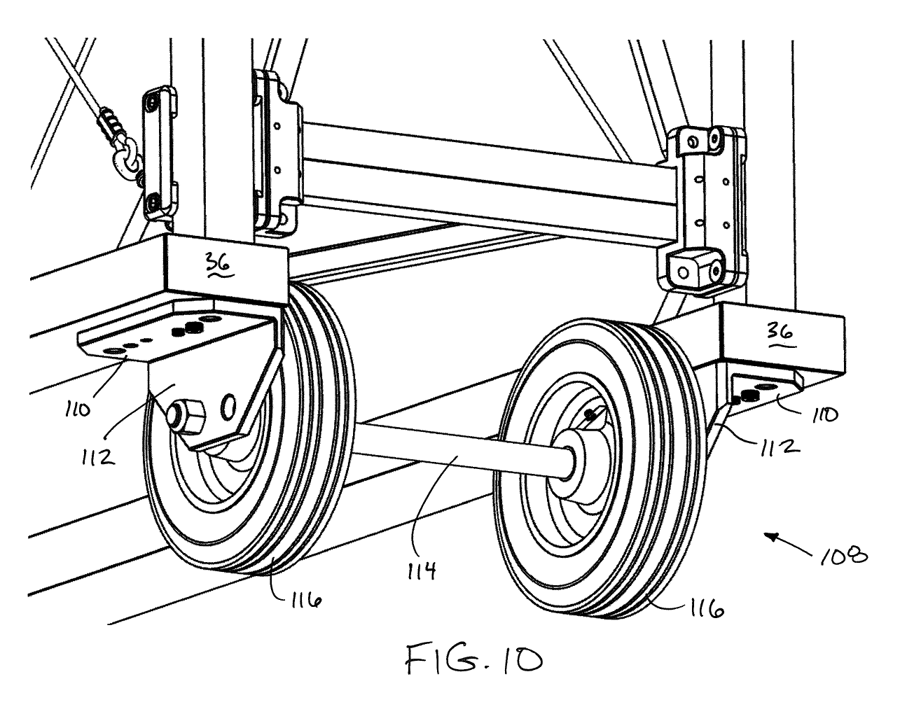

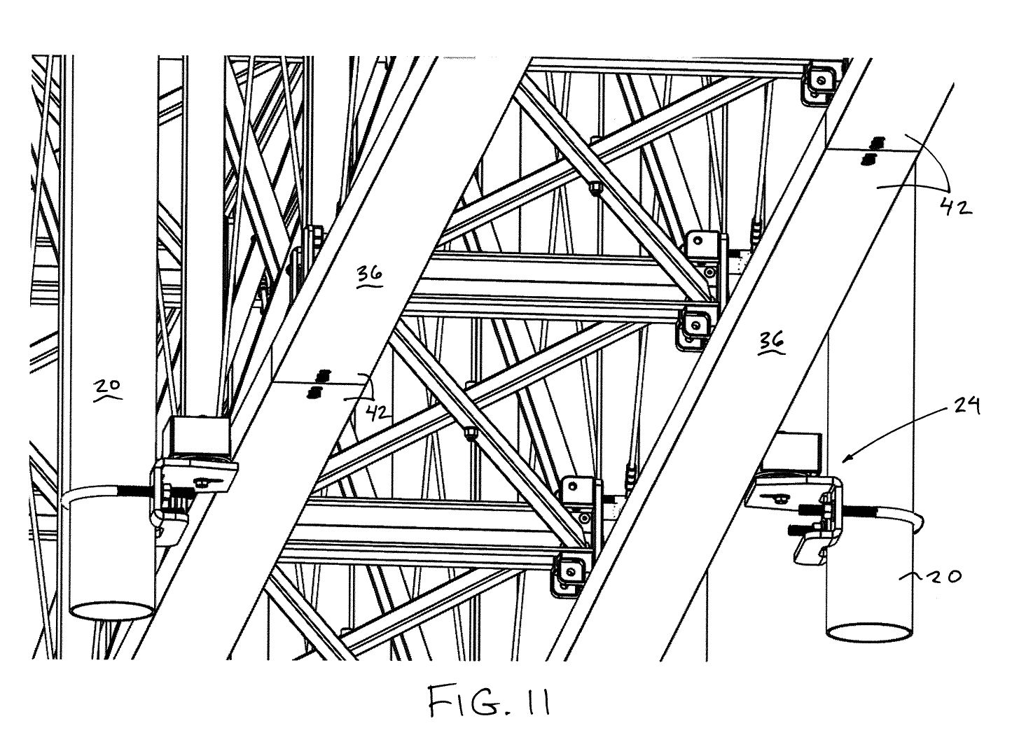

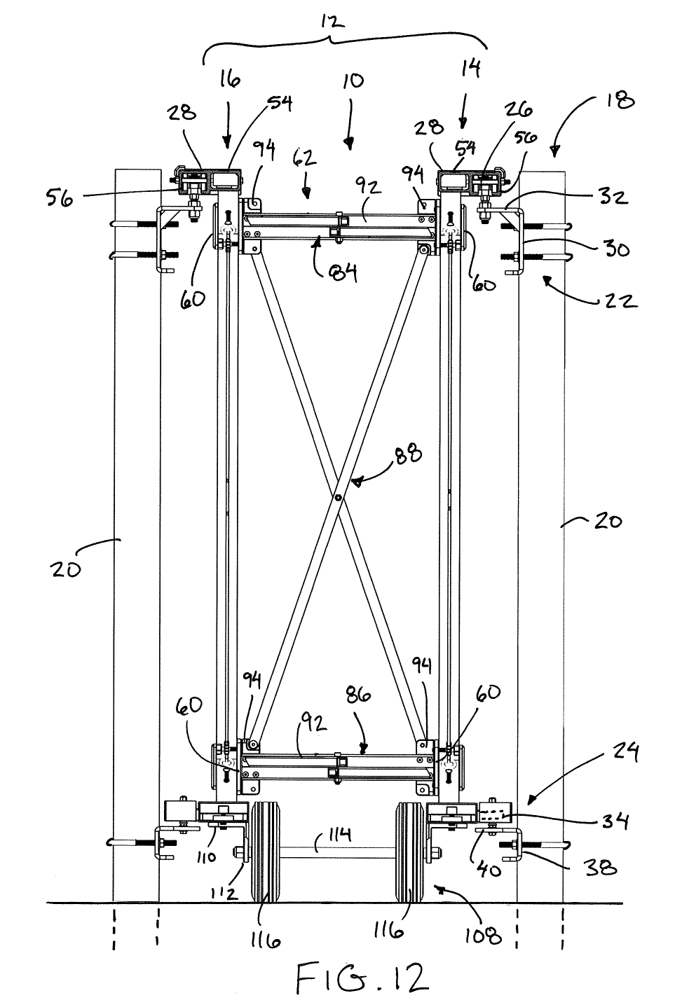

A removable centre pin 98 is coupled between the struts 96 at the intersection of the struts to lock the subassembly in the working position. Releasing of the centre pin 98 when the crossbars 90 are separated from the first and second planar frames enables the subassembly to be pivotally collapsed from the working position to a collapsed position represented in FIG. 3. The struts 96 of the subassembly lie one above the other while the height between top and bottom flanges of the C-shaped profile of each channel 92 is equal to the combined thickness of the stacked struts 96 such that the subassembly can be pivoted into a collapsed position in which the struts 96 extend parallel alongside one another while being received in a nested manner into the interior profile of each channel 92 forming the opposing crossbars 90 of the subassembly which further lie parallel and alongside the struts in the collapsed position.

The mounting blocks 94 at the opposing ends of each crossbar include mounting flanges 100 having mounting apertures therein which are arranged to receive threaded fasteners that can be threaded into the internal sockets 82 of the corresponding second clamp members mounted on the planar frames in the working position to fix the truss assembly relative to the mounting brackets.

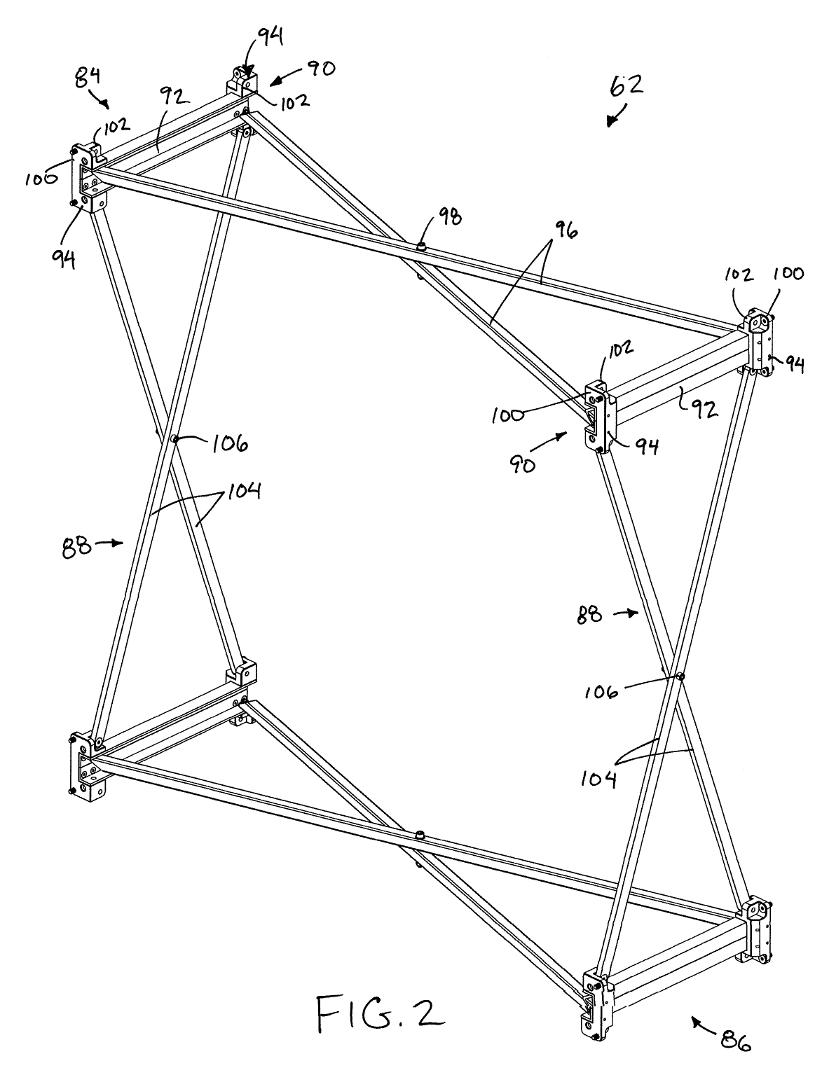

Each of the mounting blocks 94 further includes coupling flanges 102 oriented perpendicularly to the longitudinal direction of the cuboid frame having fastener apertures therein for fastening to struts 104 of the corresponding vertical frame 88. More particularly, each vertical frame comprises two struts 104 mounted between the crossbar 90 at one end of the top assembly 84 and the crossbar 90 at the corresponding end of the bottom subassembly 86 in which the struts 104 intersect one another and an X-shaped pattern. That is, each strut is mounted onto one of the crossbars at an end of the crossbar adjacent to the first planar frame 14 while being mounted on the other crossbar at an opposing end of the crossbar adjacent to the second planar frame. Accordingly, at each crossbar, the two struts of the vertical frame are mounted at opposing ends of the crossbar. A central pin 106 couples the struts 104 pivotally relative to one another at the intersection of the struts. In this manner, when the vertical frame is detached from the crossbars, the struts can be folded flat relative to one another from the working position shown in FIG. 2 to the collapsed position shown in FIG. 3 where the struts are parallel and alongside one another. In the working position, the ends of the struts are fastened to the respective coupling flanges 102 on the respective crossbars 90 of the truss assembly.

The coupling assembly 10 in some instances further includes a wheel assembly 108 arranged to be coupled to the cuboid gate frame when the overall length of the gate is unsuitable to be supported in the cantilevered manner of shorter cuboid gate frames. The wheel assembly generally includes two wheel brackets, each having a horizontal mounting flange 110 arranged to be fastened to a bottom surface of a respective bottom rail of the cuboid gate frame and a depending flange 112 extending vertically downward from an inside edge of the mounting flange in alignment with an inner side surface of the bottom rail. A wheel axle 114 is mounted laterally between the two depending flanges 112 to support the depending flanges at an overall width corresponding approximately to the width of the truss assemblies to span in the lateral direction between the first planar frame 14 and the second planar frame 16. The wheel axle 114 supports a pair of wheels 116 rotatably thereon such that the wheels are positioned adjacent to the wheel brackets at the opposing ends of the axle and so as to be located adjacent respective ones of the first planar frame 14 and the second planar frame 16. The wheels are supported about a lateral axis for rolling movement along the ground in the longitudinal direction of the cuboid gate frame.

The mounting flanges 110 include fastener apertures therein to enable fasteners to be secured through the mounting flanges into the bottom of the bottom rails of the planar frames respectively. The mounting flanges 110 may further be configured so that the fastener apertures are aligned with existing fastener apertures at the ends of the bottom rail sections of two adjacent modular sections of the planar frames such that the fastening of the mounting flange 110 to the bottom of the bottom rail of one of the planar frames acts as an additional connecting bridge spanning across the junction between abutted bottom rail sections.

The bottom roller guides 24 are configured such that the support flanges 40 do not protrude inwardly towards the other side of the gate frame beyond a boundary defined by the exterior side of the nearest planar frame. In this manner the support flanges 40 do not protrude into the path of the wheel assembly as the cuboid gate frame is displaced between the open and closed positions thereof so as not to interfere with operation of the wheel assembly.

In use, the overall gate assembly can be assembled from modular units including (i) modular sections of the first planar frame and the second planar frame and (ii) truss assemblies which can be disassembled into a top subassembly, a bottom subassembly, and two vertical frames that are each collapsible into respective collapsed positions. The modular sections of the first planar frame can be assembled to define the first planar frame and the modular sections of the second planar frame can be similarly assembled to define the second planar frame. The mounting brackets 60 are then secured to each of the first and second planar frames by clamping onto respective ones of the gusset members 50 of the planar frames between a first clamp member at the exterior side surface and a second clamp member at the interior side surface of the respective planar frame using bolts fastened between the clamping members. As described above, the clamp members are located using the locating members abutted at vertically spaced positions alongside the post while also being vertically located relative to the gusset opening using one of the locating members abutted into the interior angle between the gusset member and the post.

The truss assemblies are each assembled by unfolding the top and bottom subassemblies and pinning the struts at the intersection of the struts in the working position, followed by unfolding of the vertical frames and fastened connection of the ends of the struts of the vertical frames to respective ones of the crossbars of the top and bottom subassemblies to define the cubic shape of the overall truss assembly.

The truss assemblies are positioned end to end with one another along the length of the first and second planar frames followed by attachment of the ends of the crossbars to the corresponding mounting surfaces of the brackets 60 so that the truss assemblies span laterally between the first planar frame and the second planar frame to structurally join the first and second planar frames parallel and spaced apart from one another along laterally opposing sides of the resulting cuboid gate frame. Each truss assembly spans the full width between the first and second planar frames while spanning substantially the full height between the top and bottom rails of the planar frames in the mounted position. Collectively, the mounting of the individual truss assemblies end to end with one another to each span a respective subsection of the planar frames results in the truss assemblies also spanning the full length of the resulting cuboid gate frame. The truss assemblies thus serve to strengthen and stiffen the individual first and second planar frames 14 and 16 to increase stiffness against lateral bending.

The optional wheel assembly 108 can be additionally mounted between the first and second planar frames at one end of the cuboid gate frame where it is unsuitable to support the cuboid gate frame in a cantilevered manner due to the length of the gate opening that the cuboid gate frame must span in the closed position. The assembled cuboid gate frame is supported for movement between open and closed positions of the gate assembly in a translating movement corresponding to the longitudinal direction of the cuboid gate frame by rolling contact of the top and bottom rails of the first and second planar frames along the respective top and bottom roller guides 22 and 24 as described above.

Since various modifications can be made in the invention as herein above described, and many apparently widely different embodiments of same made, it is intended that all matter contained in the accompanying specification shall be interpreted as illustrative only and not in a limiting sense.

1. A coupling assembly arranged for assembling a first planar frame and a second planar frame to collectively define a cuboid gate frame which is elongated in a longitudinal direction and which is arranged to be operatively supported for translating movement in the longitudinal direction relative to a gate opening, the coupling assembly comprising:
a plurality of mounting brackets arranged to be mechanically coupled onto respective ones of the first planar frame and the second planar frame; and
at least one truss frame assembly arranged to be connected between the mounting brackets of said plurality of mounting brackets such that the first planar frame and a second planar frame are parallel and spaced apart from one another in a lateral direction to extend in the longitudinal direction along a length of the cuboid gate frame at laterally opposing sides of the cuboid frame;
whereby said at least one truss frame assembly stiffens each of the first planar frame and the second planar frame against bending in said lateral direction.

2. The coupling assembly according to claim 1 wherein each mounting bracket is mechanically coupled to the respective one of the first and second planar frames using threaded fasteners.

3. The coupling assembly according to claim 1 wherein each mounting bracket is arranged to be clamped onto the respective one of the first and second planar frames.

4. The coupling assembly according to claim 1 wherein each of the first and second planar frames includes a top rail, a bottom rail and a plurality of frame posts extending in fixed relation between the top rail and the bottom rail at longitudinally spaced positions, and wherein each mounting bracket is arranged to be mounted onto the respective one of the first and second planar frames adjacent a junction of one of the posts with one of the top rail and the bottom rail.

5. The coupling assembly according to claim 4 wherein each frame post of each of the first and second planar frames is secured to each of the top rail and the bottom rail of that planar frame by a respective gusset member of that planar frame, and wherein each mounting bracket further includes a locating member arranged to be received in a gusset opening between the post and the respective gusset member of the planar frame so as to be arranged to locate the mounting bracket relative to the respective planar frame.

6. The coupling assembly according to claim 1 wherein each mounting bracket is clamped onto the planar frame using threaded fasteners extending through fastener openings in the mounting bracket, and wherein the fastener openings are elongated in said longitudinal direction.

7. The coupling assembly according to claim 1 wherein said at least one truss frame assembly includes a top subassembly adjacent a top of the cuboid gate frame and a bottom subassembly adjacent a bottom of the cuboid gate frame, in which each of the top subassembly and the bottom subassembly includes two crossbars arranged to extend perpendicularly between the first planar frame and the second planar frame, and a plurality of struts connected between the two crossbars.

8. The coupling assembly according to claim 7 wherein the plurality of struts of each of the top subassembly and the bottom subassembly of said at least one truss frame assembly are pivotally attached to the crossbars such that each of the top subassembly and the bottom subassembly are pivotal between (i) a working position arranged to span a width between the first planar frame and the second planar frame and (ii) a collapsed position in which the struts lie parallel and alongside the crossbars.

9. The coupling assembly according to claim 8 wherein each of the crossbars comprises a channel member having a C-shaped profile arranged to receive at least one of the struts nested therein in the collapsed position.

10. The coupling assembly according to claim 7 wherein said at least one truss frame assembly further comprises at least one vertical frame comprising a plurality of struts coupled between the top subassembly and the bottom subassembly.

11. The coupling assembly according to claim 10 wherein the struts of said at least one vertical frame are foldable from (i) a working position arranged to span a width between the first planar frame and the second planar frame and (ii) a collapsed position in which the struts lie parallel and alongside one another.

12. The coupling assembly according to claim 1 wherein said at least one truss frame assembly comprises a plurality of truss frame assemblies arranged to be mounted longitudinally end to end with one another such that the truss frame assemblies collectively occupy the length of the cuboid frame.

13. The coupling assembly according to claim 12 further comprising at least one common mounting bracket among the plurality of mounting brackets, said at least one common mounting bracket receiving two adjacent ones of the truss frame assemblies partially mounted thereon.

14. The coupling assembly according to claim 1 further comprising a wheel assembly arranged to be mounted onto the first planar frame and the second planar frame, the wheel assembly having a pair of laterally opposing mounting flanges arranged to be mounted onto the first planar frame and the second planar frame respectively while the wheel assembly spans a width of the cuboid frame in the lateral direction.

15. The coupling assembly according to claim 14 wherein the first planar frame and the second planar frame each comprise a modular frame formed of modular sections joined longitudinally end to end with one another, and wherein the mounting flanges of the wheel assembly are each arranged to span a junction between an adjacent pair of the modular sections of the such that the mounting flange forms a bridge connected to each modular sections of the adjacent pair.

16. A gate assembly comprising:
a stationary frame arranged to be supported on ground adjacent to a gate opening; and
a cuboid gate frame which is elongated in a longitudinal direction and which is supported on the stationary frame for translating movement in the longitudinal direction relative to a gate opening between a closed position spanning the gate opening and an open position in which the gate opening is substantially unobstructed by the cuboid gate frame;
the cuboid gate frame comprising:
a first planar frame and a second planar frame extending in the longitudinal direction along a length of the cuboid frame at laterally opposing sides of the cuboid gate frame such that the first planar frame and the second planar frame are parallel and spaced apart from one another in a lateral direction; and
a coupling assembly coupling the first planar frame and the second planar frame, the coupling assembly comprising (i) a plurality of mounting brackets mechanically coupled onto respective ones of the first planar frame and the second planar frame, and (ii) a plurality of truss frame assemblies arranged to be connected between the mounting brackets of said plurality of mounting brackets to span a width of the cuboid gate frame between the first planar frame and the second planar frame in the lateral direction whereby the truss frame assemblies stiffen each of the first planar frame and the second planar frame against bending in the lateral direction.

17. The gate assembly according to claim 16 wherein the truss frame assemblies are arranged to be mounted longitudinally end to end with one another such that the truss frame assemblies collectively occupy the length of the cuboid frame.

18. The gate assembly according to claim 16 wherein each truss frame assembly among the plurality of truss frame assemblies comprises longitudinally opposed first and second crossbars extending perpendicularly between the first planar frame and the second planar frame and a plurality of struts pivotally connected between the first and second crossbars such that the truss frame assembly is pivotal between (i) a working position arranged to span a width between the first planar frame and the second planar frame and (ii) a collapsed position in which the struts lie parallel and alongside the first and second crossbars.

19. The gate assembly according to claim 16 further comprising a wheel assembly arranged to be mounted onto the first planar frame and the second planar frame, the wheel assembly having a pair of laterally opposing mounting flanges arranged to be mounted onto the first planar frame and the second planar frame respectively while the wheel assembly spans a width of the cuboid frame in the lateral direction.

20. The gate assembly according to claim 19 wherein the wheel assembly includes two wheels supported adjacent to the first and second planar frames respectively, and wherein the stationary frame comprises a bottom roller guide mounted thereon at each of the laterally opposing sides of the cuboid frame adjacent to a bottom of the cuboid gate frame, each roller guide comprising a support flange supporting an exterior guide wheel thereon for rolling engagement with an exterior side surface of the cuboid gate frame, the support flange being mounted in a non-interfering relationship with the wheels of the wheel assembly as the cuboid gate frame is displaced between the open position and the closed position thereof.
